(19) United States
(12) Patent Application Publication
(10) Pub. No.: US 2022/0383337 A1
(43) Pub. Date: Dec. 1, 2022

(54) CROSS-ENTITY TRANSACTION AND RETURN DATA INTEGRATION SERVICES

(71) Applicant: NCR Corporation, Atlanta, GA (US)

(72) Inventors: Christopher John Costello, Suwanee, GA (US); Matthew Robert Burris, Atlanta, GA (US); Itamar David Laserson, Givat Shmuel (IL); Norman Leonard Trujillo, Frisco, TX (US)

(21) Appl. No.: 17/333,104

(22) Filed: May 28, 2021

(51) Int. Cl. G06Q 30/00; G06Q 30/06; G06Q 20/40; G06Q 20/20

(52) U.S. Cl. CPC G06Q 30/0185; G06Q 30/0609; G06Q 20/4016; G06Q 20/407; G06Q 20/202; G06Q 20/203

(57) ABSTRACT

A cross-entity and cross-retailer platform is provided that captures transaction and item return data, indexes, and stores the data in a cloud-accessible data store. A service is provided that custom processes retailer and entity-defined workflows based on purchase transactions and return transactions using the data store. The entities may comprise manufacturers of an item, a supplier of the item, a distributor of the item, and a Consumer Packaging Goods (CPG) company of the item. In an embodiment, a given entity workflow causes the service on a given return to calculate a custom aggregation of returns for a given item or a given set of items across different retailers within a given geographical region for a select period of time and provide selective data about the returns automatically to an inventory system and/or a schedule/delivery system of the given entity through an Application Programming Interface (API).

### BACKGROUND

Annually, consumers return merchandise in significant numbers. Retailers rarely retain useful information about why a given consumer is returning an item. Typically, manufacturers, distributor, and/or suppliers of the merchandise do not receive whatever information the retailers do acquire from the consumers during the returns or if they do receive the information is it untimely provided and likely aggregated on a weekly, monthly, and/or quarterly basis.

Essentially, transactional merchandise suppliers have limited useful information their own item returns data. As a result, these suppliers have developed a variety of ad hoc techniques to infer information from data associated with different portions of their merchandise supply line, but the data is late and provides an incomplete picture of their item returns data.

There are numerous logistical problems that suppliers could solve and numerous cost improvements that suppliers could make if they had access to timely and relevant information for their item returns.

For example, a supplier schedules the load and delivery routes of its trucks for distribution to their retailers based on available inventory and a variety of other known factors. The truck routes and truck loads are strictly preplanned for optimization, but they do not account for item returns that may be awaiting them at some of the retailer stops. This unknown factor can greatly disrupt deliveries when unexpected pickups are needed. In some cases, a delivery truck's capacity can be exceeded with the returns, such that it would have made more sense to route the truck to other retailer stops to offload inventory before taking on the returns at one of the initial planned stops if the supplier had a forewarning about the item pickups before the truck route was finalized.

As another example, one the most common forms of fraud is for a customer to buy an item at one retailer location when the item was on sale or had a promotion and then return the item to a different retailer entirely or to a different store of a same retailer for the full non-discounted item price.

Information associated with returned merchandise are unknown factors from the perspective of the manufacturers, distributors, and/or suppliers such that when the information is eventually known, the information is stale and of little value because it became known long after quantitative and qualitative decisions were made. As a result, returns information cannot be timely evaluated for purposes of improving product/item development, improving business planning (manufacture, distribution, inventory, truck load optimization, truck route optimization, etc.), and identifying quality organizations for partnerships in handling, selling, and distributing the merchandise.

### SUMMARY

In various embodiments, methods a system for cross-entity transaction and return data integration services are presented.

According to an embodiment, a method for operating a cross-entity transaction and a return data integration service is presented. As an example, item return data is received that is associated with a return of an item from a retailer during an item return transaction. An entity other than the retailer is identified from the item return data. An item return workflow associated with the entity is obtained and the item return workflow is processed causing select data from the item return data to be delivered to the entity.

### BRIEF DESCRIPTION OF THE DRAWINGS

FIG. 1 is a diagram of a system/platform for cross-entity transaction and return data integration services, according to an example embodiment.

FIG. 2 is a diagram of a method for operating a cross-entity transaction and return data integration service, according to an example embodiment.

FIG. 3 is a diagram of another method for operating a cross-entity transaction and return data integration service, according to an example embodiment.

### DETAILED DESCRIPTION

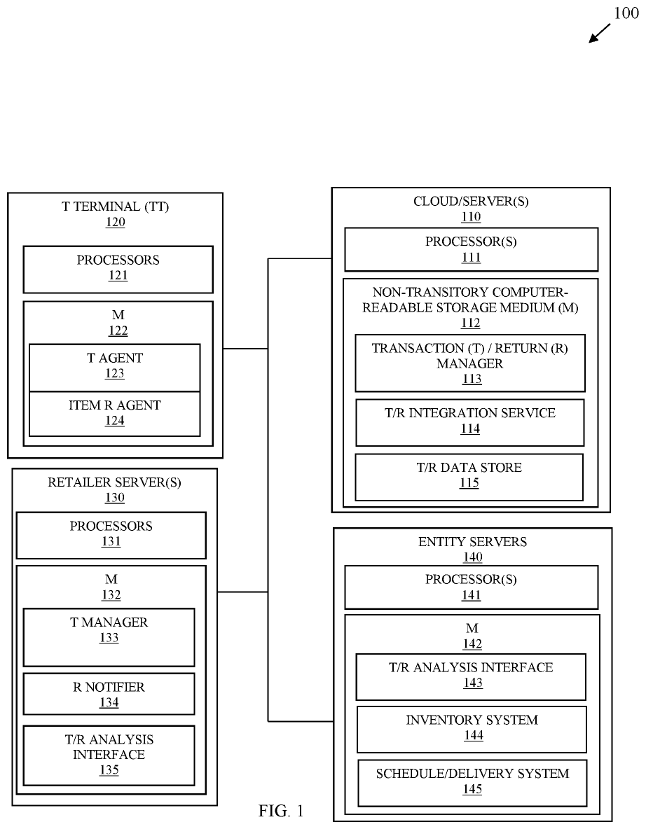

FIG. 1 is a diagram of a cross-entity system/platform 100 for cross-entity transaction and return data integration services, according to an example embodiment. It is to be noted that the components are shown schematically in greatly simplified form, with only those components relevant to understanding of the embodiments being illustrated.

Furthermore, the various components (that are identified in system/platform 100) are illustrated and the arrangement of the components are presented for purposes of illustration only. It is to be noted that other arrangements with more or less components are possible without departing from the teachings of the cross-entity transaction and return data integration services, presented herein and below.

System/platform 100 (herein after just “system 100”) provides a processing environment by which entities (e.g., Consumer Product Goods manufacturers (CPGs), item suppliers, item distributors, and item retailers) can obtain valuable item data relationships, correlations, and insights from item transactions and, more particularly item returns that span multiple different or cross entities via a cloud-based service accessible to each of the entities for purposes of modifying and altering decision making by systems of the entities. Further, near real-time notifications of item transaction and item returns are provided to the entities via the service. Transaction data associated with item sales and returns data associated with item returns are categorized and correlated by entity identifiers and by item codes within a cloud-accessible data store. An item transaction/return manager interacts with the appropriate entity inventory systems and/or schedule/delivery systems to provide real-time notice of items returned as input to inventory deliveries/pickups decision making. This allows the entities to properly account in real time for item inventories, item deliveries, and item pickups by their corresponding systems. Moreover, an integration service permits the entities to query and obtain return item data relationships, correlations, and insights from the cloud-accessible data store.

The term “item” may be used interchangeably and synonymously with the terms “product,” “merchandise,” and/or “good.”

As used herein the term “manufacturer” is used to identify a company that manufactures an item/product. A “supplier” is used to identify a company that supplies the item/product of a manufacturer to a distributor; in some instances, the supplier may also be the manufacturer of the item/product. A Consumer-Packaged Goods (CPG) company is an entity that manufacturers the item/product and then provides the item/product directly to a retailer for resale to a consumer. A distributor is used to identify a company that provides the item/product of a manufacturer (or a supplier that is also the manufacturer) directly to a retailer.

As used herein the term “company” or the term “entity” refers to a manufacturer, a supplier, a CPG, and/or a distributor.

The term “retailer” refers to an organization that resells an item/product directly to the consumer.

A “transaction terminal 120” is a type of device that is used to perform transactions (purchases and returns), which may also include a variety of integrated peripheral devices or which may be interfaced to peripheral devices. The peripheral devices may comprise card readers, currency/coin acceptors and dispensers, scanners, weigh scales, integrated scanners with weigh scales, touch displays, cameras, etc.

A consumer device may also be considered a transaction terminal 120 when the consumer device is being operated by a consumer for purposes of performing an item return, such that in some embodiments, the transaction terminal 120 is a phone, a laptop, a desktop, a tablet, a voice-based network-enabled device (Google® Home®, Amazon® Echo®, etc.), etc.

A retail staff operated device can also be a transaction terminal 120 when a staff member operates the device for purposes of performing an item return on behalf of a customer. The staff operated device may be a Point-Of-Sale (POS) terminal, a tablet, a phone, a laptop, or a desktop.

In some cases, a consumer performs a self-item return via a transaction terminal 120 located within a retail store, such that in these situations the transaction terminal 120 is a Self-Service Terminal (SST) or a kiosk.

System 100 comprises a cloud/server 110, a transaction terminal 120, retailer servers 130, and entity servers 140.

Cloud/Server 110 comprises at least one processor 111 and a non-transitory computer-readable storage medium 112. Medium 112 comprises executable instructions for transaction/return manager 113, transaction/return integration service 114, and transaction/return data service 115. The executable instructions when provided to processor 111 from medium 112 cause processor 111 to perform the processing described herein and below with respect to 113-115.

Transaction terminal 120 comprises at least one processor 121 and a non-transitory computer-readable storage medium 122. Medium 122 comprises executable instructions for transaction agent 123 and item return agent 124. The executable instructions when provided to processor 121 cause processor 121 to perform the processing described herein and below with respect to 123-124.

Each retailer server 130 comprises one or more processors 131 and non-transitory computer-readable storage medium 132. Medium 132 comprises executable instructions for transaction manager 133, return notifier 134, and transaction/return analysis interface 135. The executable instructions when provided to one or more processors 131 from medium 132 cause processors 131 to perform the processing described herein and below with respect to 133-135.

Each entity server 140 comprises one or more processors 141 and non-transitory computer-readable storage medium 142. Medium 142 comprises executable instructions for transaction/return analysis interface 143, inventory system 144, and schedule/delivery system 145. The executable instructions when provided to one or more processors 141 from medium 142 cause processors 141 to perform the processing described herein and below with respect to 143-145.

Terminal 120 performs transactions for selling items and performing item returns at a retailer store. Transaction agent 123 of retailer server 130 processes a transaction purchase workflow that interacts with transaction manager 133 for purposes of completing a transaction to sell an item to a consumer on behalf of a retailer at the retailer store or online (via a web-based or app-based interface—online transactions may utilize a consumer device as terminal 120 (such as consumer phone, tablet, laptop, etc.)). Item return agent 124 processes a return workflow that interacts with transaction manager 133 for purposes of completing a return (item return) transaction associated with a previous item purchased by a consumer on behalf of a retailer at the retailer store or online (via a web-based or app-based interface—again, online returns may utilize a consumer device as terminal 120 (such as consumer phone, tablet, laptop, etc.)).

Transaction manager 133 processes both item purchase transaction workflows and item return transaction workflows through interaction with transaction agent 123 and item return agent 124. The item return workflow is enhanced and modified with the teachings presented herein, such that during an item return transaction, transaction manager 133 notifies return notifier 134 of the item return along with item return data gathered by item return agent 124, transaction manager 133, and return notifier 134 from a retailer's transaction, product/item catalogue, and/or customer loyalty data stores.

Item return data may comprise, a customer identifier (if available) for the customer associated with the item return, a customer profile (if available) associated with the customer identifier, an item code for the item (such as Universal Product Code (UPC)), item pricing, item category, item description, a transaction type that identifies an item return transaction versus a purchase transaction, a channel identifier for a channel being used for the return (e.g., in person at a POS terminal 120, in person at a SST 120, online via a consumer device acting as terminal 120 through a mobile application of the consumer device, via a call center through an agent that operates a terminal 120, etc.) transaction identifier for the original purchase transaction of the item by the customer (if available), a terminal identifier for the terminal 120, a store identifier for the store associated with the item return, geographical location data for the store, a purchase transaction store identifier for the store associated with the original item purchase (if available), planogram data for shelf location of the item within the store, geographical data for the store associated with the original purchase transaction, a retailer identifier for the retailer, a transaction history for the customer (if available), entity identifiers for the manufacturer, supplier, distributor, and/or CPG associated with the item code (there may be one to several entity identifiers for a single item return), customer demographic data or customer segmentation data for the customer maintained in the loyalty data store (if available), calendar date for the item return, day of the week for the item return, time of day for the item return, and/or any item return reason code that identifies a selected reason why the customer is returning the item (if available through item return agent 124 and/or transaction manager 133).

It is to be noted also terminal 120 may be a mobile device operated by the consumer (consumer device), such that the mobile device reports through item return agent 124 a current geographical location of the mobile device using the device's location services.

Moreover, item return data may comprise additional information available to retailer from their data stores from what was presented above or less information from what was presented above.

Further, customer profile data of the item return data may comprise customer contact information (such as mobile device number, email address, social media identifiers, etc.), customer name, customer loyalty level, preferred contact channel of customer (e.g., via email, text, and/or voice call).

Return notifier 134 sends an item return transaction identifier for the item return in real time along with the item return data to transaction/return manager 113 of cloud 110 as the item return is being processed on terminal 120.

During purchase transaction, transaction details are gathered by transaction agent 123 and transaction manager 133 and reported from transaction manager 133 to transaction/return manager 133 of cloud 110. Transaction details may include all or or some subset of item return data (except item return reason code which would be inapplicable to a purchase transaction). The transaction details may also include additional information that was not applicable or available for an item return but is for a purchase transaction, such as any promotion identifier for a promotion that was applied to the item price of the item code and any promotion details/pricing discount for the item. Note also that the transaction details comprise a transaction identifier, a transaction type of a purchase transaction, a transaction calendar day, a transaction time of day, and a transaction day of week for the purchase transaction as opposed to the corresponding item return data elements listed above for the item return data.

Transaction/Return manager 113 indexes, links, and stores the transaction details and the item return data in transaction/return data store 115 based on the retailer identifier for the retailer, store identifier, the entity identifiers (for the manufacturer, supplier, distributor, and/or CPG), the item identifier (UPC) for the returned item, any promotion identifier for any promotion associated with a corresponding purchase transaction, a customer identifier for the customer (if available), and the item return transaction identifier or transaction identifier.

Each record in data store 115 comprises item return data or transaction details for the corresponding item return transaction or for the corresponding purchase transaction. Furthermore, some retailers may comprise their own unique entity identifiers for distributors or suppliers, such that transaction/return manager 113 may maintain lookup tables that map a given distributor's or a given supplier's retail-specific entity identifier and associated it to a unique entity identifier for the given distributor or supplier maintained by cloud 110. The manufacture of the purchased or returned item will contain an already unique manufacturer identifier for the manufacturer of the item within the UPC code (item code).

In some embodiments, mapping tables to distinguish unique customer identifiers across retailers may also be used by transaction/return manager 113 for purposes of identifying a unique customer across different retailers that is associated with different retailer-assigned customer identifiers. In this embodiment, a globally unique customer identifier for a customer may be maintained and managed by transaction/return manager 113 across a plurality of retailers.

Transaction/Return integration service 114 receives notification from transaction/return manager 113 upon insertion of a purchase transaction or item return transaction. Note that this notification may also be detected by transaction/return integration service 114 based on monitoring the transaction/return data store 115 for insertion of records. The corresponding record from the data store 115 is obtained and the retailer identified along with the entity identifiers (manufacturer identifier available from the UPC (item code) whereas other types of entities (supplier, distributor, or CPG) may require a mapping table lookup based on the retailer identifier for the record that was added to the data store 115).

Transaction/Return integration service 114 identifies the transaction type of the record and determines when a transaction type is an item return. Transaction/Return integration service 114 access workflows for each of the entities identified in the record associated with a transaction type of the item return and transaction/return integration service 114 processes each of the workflows using the record. Note that one to several workflows may be processed by integration service 114 and the exact number of workflows is dependent on the entity identifiers and corresponding entities having registered a workflow with cloud 110. At least one workflow is processed for one of the entities. The entities' item return workflows are customized by or for each entity.

As an example, a given distributor entity workflow associated with the item return may instruct the integration service 114 to query the data store 115 and tabulate all item returns for the item being returned or for any returned item that has been noted within a current interval of time (such as one day, past 12 hours, past three days, past week, past month) and report the tabulated total along with the corresponding item identifiers and select information for each of the corresponding records when the tabulated total exceeds a predefined threshold before the current interval of time expires. When the tabulated total never exceeds the predefined threshold within the current interval of time, the workflow instructs integration service 114 to report current tabulated totals and the select information from the corresponding records at the expiration of the current interval of time.

Integration service 114 may report the totals and information directly to the entity's inventory system 144 via an Application Programming Interface (API) associated with the corresponding inventory system 144 of the corresponding entity. The tabulated totals may be per unique item identifier, per retailer, per geographical region or location that spans multiple different stores of a same retailer or spans multiple different stores of different retailers, and/or per any custom aggregation with custom conditions and/or customer intervals of time/threshold totals defined by the entity within the workflow. Moreover, the workflow may define the format and types of data that is to be reported to inventory system 144 via the API by integration service 114.

Each entity workflow can custom define what event and/or what item return total (per specific item or per aggregates of different items) triggers a report out by integration service 114 to inventory system 144. Specific entity defined conditions and time intervals can also be defined before a report out is triggered.

Similarly, each entity's custom workflow can trigger report outs from integration service 114 to the entity's schedule/delivery system 145. Again, the format of the reported-out information and the types of data reported out can be customized by the entity.

Thus, integration service 114 acts as a real-time monitor of item returns for each interested entity and when entity-defined conditions are met, aggregated information and select record data can be delivered as input to the entity's inventory system 144 and/or schedule/delivery system 145. This allows inventory, scheduling, truck loading, and truck routes to account in the optimization processing for real-time relevant item return data. So, delivery truck capacity and routes can account for items that require pickup at the retailers and account for items being delivered from inventory to the same retailers. This is completely automated and in real time and achieved via data store 115 maintained and custom mined (based on each entity's item return workflow) by transaction/return manager 113 and transaction/return integration service 114.

Each entity may have more than 1 customized workflow (multiple workflows) processed by integration service 114. For example, large items such as furniture may have a single customized item return workflow whereas smaller items such as consumables (toner, paper, batteries, etc.) have a different customized item return workflow. Alternatively, each item type can include its own item return workflow instructions within a portion of a single entity's item return workflow, such that integration service 114 processes the corresponding portion based on an item type assigned to a given item UPC for a given item return.

In an embodiment, an optimized truck route generated by a given schedule/delivery system 145 from selective information reported by integration service 114 may have returned items that are picked up by a given truck along the route at a first retailer dropped off as part of an order fulfillment request at a second and different retailer along the route.

In an embodiment, a customized workflow for a given entity may instruct integration service 114 to generate and deliver a report for a given item return or a custom aggregation of returns to transaction/return analysis interface 143 and/or to a designated resource address (such as email, text number, social media account via private messaging, etc.).

In an embodiment, the customized workflow processed by integration service 114 may just report selective item return data and/or selective aggregated item return data to a designated resource address, to transaction/return analysis interface 143, to inventory system 144 via an API, to schedule/delivery system 145 via an API, and/or to any combination or all of these things based on a given item return transaction or based on a collection of item return transactions.

Control over what item return data is reported out (how much of the item return data and/or aggregations of item return data), to whom the data is reported out (resource address, interface 143, inventory system 144, and/or schedule/delivery system 145), how the data is reported out (format and types of data, API, and when the data is reported out (conditions or events) may all be custom defined for a given entity within its item return workflow and automatically processed and monitored in real time by integration service 114.

Additionally, both the retailers and the entities can access data store 115 and perform queries and generate reports via interface 135 of retailer servers 130 and via interface 143 of entity servers 140. That is, a user-facing interface to integration service 114 is provided through interface 135 to the retailers and is provided through interface 143 to the entities. The retailers and entities can provide custom search criteria through the user-facing interface to integration service 114. Integration service 114 then processes the search criteria against data store 115 and returns search results back to the entities or retailers via interfaces 143 and 135.

As an example, a given manufacturer (one type of entity as discussed above) may operate interface 144 to generate a report for all returns of a given item code within the last seven days at a given retailer, at a given store for a given retailer, at a given set of stores that spans multiple different retailers, at a custom set of retailers, or within a given geographical region. The queries and reports can be based on item types, specific item identifiers, specific calendar dates, within a range of calendar dates, based on custom geographical locations, etc.

In an embodiment, integration service 114 can map a given item return directly back to a promotion via searching the data store 115 for purchase transaction types that include the item code and that also include a promotion and discovering purchase transaction records having the promotion, which can then be linked the customer associated with the item return back to a specific one of the purchase transaction records based on information included within the purchase transaction record and the item return transaction record (for example a customer identifier) even when no receipt is provided for the item return. When integration service 114 maps the customer identifier to a globally unique customer identifier, integration service 114 can even discover the original purchase transaction when the customer does not provide an original transaction receipt for the item return transaction. This can catch fraud when the customer buys the item at one retailer store or online and attempts to return the item at a different retailer.

The integration service may also score the item return data and use it to search scores associated with known fraudulent item returns for purposes of providing a fraud score. In these embodiments, integration service 114 may send a notification or real-time alert back to transaction manager 133 as part of a retailers return workflow, such that transaction manager 133 can decline the item return in real time via notification to item return agent 124. A threshold fraud score may be used by integration service 114 to determine when an alert or notification is to be sent.

In still another embodiment, integration service 114 may process an item return fraud workflow independent of the entity workflows for each item return. For example, integration service 114 counts item returns for each item associated with item returns that spans multiple different retailers in accordance with the fraud workflow and maintains a threshold that when exceed is used to send an alert to the retailers. Suppose item X is being returned in larger than the threshold totals at retailers R1 and R2; the fraud workflow then instruction integration service 114 to inspect purchase transactions for the item occurring at retailers R1, R2, R3, and R4 for promotions and discovers that X is on promotion at a discounted price at retailer R3 and R4 but not being discounted at retailers R1 and R2. Moreover, the X returns are taking place at retailers R1 and R2, which is coincidentally not where all or most of the original purchase transactions for X originate (originate at R3 and R4). Integration service 114 sends an alert to designated resource addresses or interfaces 135 informing R1, R2, R3, and R4 of the perceived pattern and potential fraud, such that the retailers can stop it from continuing to limit the loss to retailers.

Thus, integration service 114 may have its own retailer independent workflows that it processes for detecting patterns of fraud or trends in purchases and returns, which can be reported to the retailers and the entities when a pattern and/or a trend is identified.

It is to be noted that data store 115 can be organized in any number of manners, such as via tables by retailer, tables by store of retailer, etc. When integration service 114 processes the workflows, the appropriate tables need that span multiple different retailers or that are associated with just one retailer or store of the retailer can be searched selectively. In this manner, transaction identifiers are unique for a given retailer or a given score within a given table, but the integration service can search across multiple different tables associated with multiple different retailers when conditions defined in an entity workflow dictate.

Each entity or even retailer can have custom workflows for both item returns and purchase transactions. For example, a retailer may have a purchase transaction workflow that notifies transaction manager 133 when a predefined total of items of a specific type are purchased within a retailer-set period of time. This can assist the retailer in order management and shelf space management. This is but one example and it is to be understood that a variety of retailer and entity-based needs can drive their purchase transaction workflows and item return workflows.

In an embodiment, the item return is pre-staged via a mobile or user-owned and controlled device (laptop, desktop, phone, wearable processing device, etc.). In this embodiment, the user-owned device serves as a first terminal 120 where the pre-staged item return is initiated. Subsequent to the pre-staging, the consumer goes to a store of the retailer and accesses an SST (a second terminal 120) for a self-item return that was pre-staged via the consumer's device for completing the item return on the SST. It may also be that the instore terminal 120 is a POS terminal operated by staff of the retailer to complete the pre-staged item return on behalf of the consumer. In this embodiment, there may be two transaction terminals 120 (the pre-staged consumer operated device and the instore terminal where the pre-staged item return is completed). During the pre-stage workflow, the item return agent 124 interacts with transaction manager 133 and provides the notification to transaction/return manager 113 that the item return is being pre-staged and will be completed later within a store of the retailer.

Transaction/Return manager 113, transaction/return integration service 114, and transaction/return data store 115 collective present and provide cross-entity transaction and return data integration services to the retailers and the entities. This allows insightful information to be timely processed and fed to entity-based systems to adjust for item returns and to more quickly identify fraudulent returns or fraudulent return patterns and/or trends.

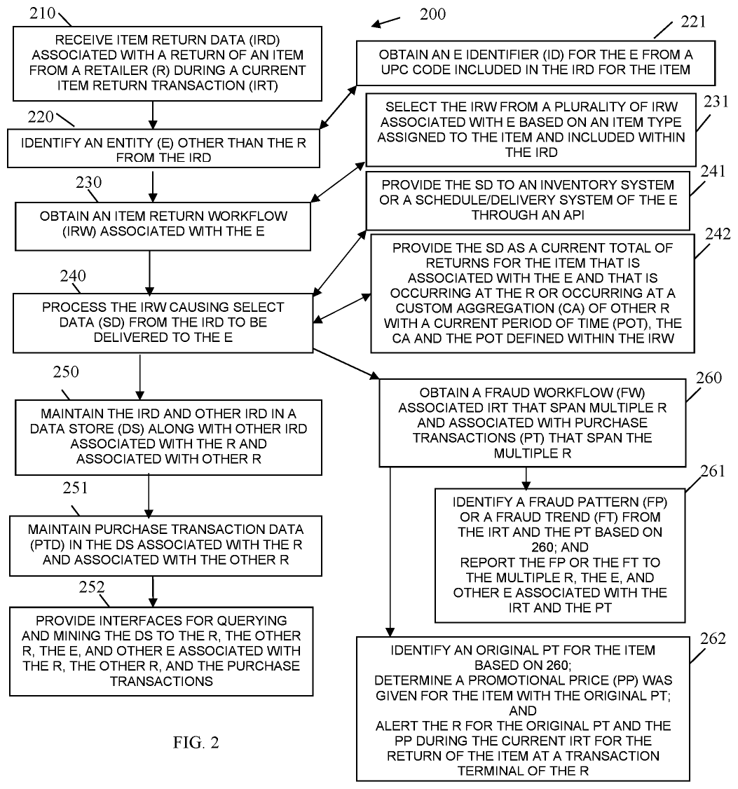

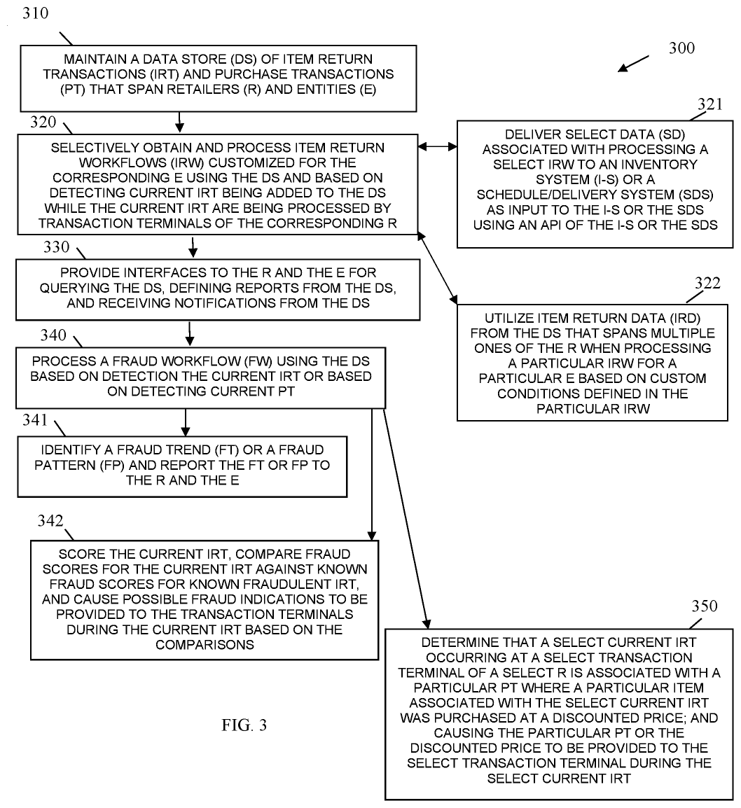

These and other embodiments are now discussed with reference to FIGS. 2-3.

FIG. 2 is a diagram of a method 200 for operating a cross-entity transaction and return data integration service, according to an example embodiment. The software module(s) that implements the method 200 is referred to as a “cross-entity/retailer return data service.” The cross-entity/retailer return data service is implemented as executable instructions programmed and residing within memory and/or a non-transitory computer-readable (processor-readable) storage medium and executed by one or more processors of one or more devices. The processor(s) of the device that executes the cross-entity/retailer return data service are specifically configured and programmed to process the cross-entity/retailer return data service. The cross-entity/retailer return data service may have access to one or more network connections during its processing. The network connections can be wired, wireless, or a combination of wired and wireless.

In an embodiment, the device that executes the cross-entity/retailer return data service is cloud 110. In an embodiment, cloud 110 comprises a plurality of servers logically cooperating and accessible as a single server 110 (cloud 110).

In an embodiment, the cross-entity/retailer return data service is all or some combination of 113-114.

At 210, the cross-entity/retailer return data service receives (dynamically and in real time) item return data associated with a return of an item from a retailer during a current item return transaction at a terminal 120 associated with the retailer.

At 220, the cross-entity/retailer return data service identifies an entity other than the retailer from the item return data. Again, an entity comprises any of manufacturers of the item, suppliers of the item, distributors of the item, or CPG companies associated with the item.

In an embodiment, at 221, the cross-entity/retailer return data service obtains an entity identifier for the entity from a UPC code included in the item return data for the item.

At 230, the cross-entity/retailer return data service obtains an item return workflow associated with the entity (via an entity identifier).

In an embodiment, at 231, the cross-entity/retailer return data service selects the item return workflow from a plurality of item return workflows associated with the entity and based on an item type or an item category; the item type assigned to the item and included within or derived from the item return data.

At 240, the cross-entity/retailer return data service processes the item return workflow causing select data from the item return data to be delivered to the entity.

In an embodiment, at 241, the cross-entity/retailer return data service provides the select data to an inventory system 144 or a schedule/delivery system 145 of the entity through an API.

In an embodiment, at 242, the cross-entity/retailer return data service provides the select data as a current total of returns for the item or for a selection grouping of items that is associated with the entity and this is occurring at the retailer or occurring at a custom aggregation of other retailers within a current period of time. The custom aggregation and the current period of time (or interval of time) is defined within the item return workflow.

In an embodiment, at 250, the cross-entity/retailer return data service maintains the item return data in the data store along with other item return data associated with the retailer and associated with other different retailers.

In an embodiment of 250, at 251, the cross-entity/retailer return data service maintains purchase transaction data in the data store that is associated with purchase transactions of the retailer and that is associated with the other different retailers.

In an embodiment of 251, at 252, the cross-entity/retailer return data service provides interfaces 135 and 143 for querying and mining the data store to the retailer, the other retailers, the entity, and other entities, which are associated with the retailer, the other retailers, and the purchase transactions.

In an embodiment, at 260, the cross-entity/retailer return data service obtains a fraud workflow associated with the item return transaction and other item return transactions that span multiple retailers and that is also associated with purchase transactions that span the multiple retailers.

In an embodiment of 260, at 261, the cross-entity/retailer return data service identifies a fraud pattern or a fraud trend from the item return workflow based on processing of 260. The cross-entity/retailer return data service then reports the fraud pattern of the fraud trend to the multiple retailers (which includes the retailer and different retailers), the entities, and other entities associated with the item return transaction, the other item return transactions, and the purchase transaction.

In an embodiment of 260, at 262, the cross-entity/retailer return data service identifies an original purchase transaction for the item based on processing the fraud workflow at 260. The cross-entity/retailer return data service determines from the original purchase transaction that a promotional price was given for the item with the original purchase transaction. The cross-entity/retailer return data service alerts the retailer to the original purchase transaction and the promotional price during the current item return transaction for the return of the item at a transaction terminal 120 of the retailer where the current item return transaction is in progress with a consumer.

FIG. 3 is a diagram of another method 300 for operating a cross-entity transaction and return data integration service, according to an example embodiment. The software module(s) that implements the method 300 is referred to as a “cloud-based cross entity and cross retailer return data integration service.” The cloud-based cross entity and cross retailer return data integration service is implemented as executable instructions programmed and residing within memory and/or a non-transitory computer-readable (processor-readable) storage medium and executed by one or more processors of a device. The processors that execute the cloud-based cross entity and cross retailer return data integration service are specifically configured and programmed for processing the cloud-based cross entity and cross retailer return data integration service. The cloud-based cross entity and cross retailer return data integration service may have access to one or more network connections during its processing. The network connections can be wired, wireless, or a combination of wired and wireless.

In an embodiment, the device that executes the cloud-based cross entity and cross retailer return data integration service is cloud 110. In an embodiment, the device that executes the item return transaction integration manager is server 110.

In an embodiment, the cloud-based cross entity and cross retailer return data integration service is all of or some combination of 113-114 and/or method 200 of FIG. 2.

The cloud-based cross entity and cross retailer return data integration service presents another and, in some ways, enhanced processing perspective of the what was discussed above for cloud 110 and method 200.

At 310, cloud-based cross entity and cross retailer return data integration service maintains a data store 115 of item return transactions and purchase transaction that span retailers and entities (a plurality of different retailers and different entities).

At 320, the cloud-based cross entity and cross retailer return data integration service selectively obtains and processes item return workflows that are customized for the corresponding entities using the data store 115 based on detecting a current item return transaction being added to the data store 115 while the current item return transaction is being processed by transaction terminals 120 of the corresponding retailers.

In an embodiment, at 321, the cloud-based cross entity and cross retailer return data integration service delivers select data associated with processing a select item return workflow to an inventory system 144 or a schedule/delivery system 145 as input to the inventory system 144 or the schedule/delivery system 145 using an API of the inventory system 144 of the schedule/delivery system 145. The input provided to system 144 or system 145 is used for decision making and planning, such as determining contents and capacity of inventory items on delivery trucks, generating optimal routes for deliveries of the trucks, etc. in order to account for items being picked up along the routes that were returned by various retailers to the corresponding entity.

In an embodiment, at 322, the cloud-based cross entity and cross retailer return data integration service utilizes item return data from the data store that spans multiple ones of the retailers when processing a particular item return workflow for a particular entity based on custom conditions defined within the particular workflow. For example, a CPG company may want aggregations of returns within a configure interval of time or time period as was discussed above.

At 330, the cloud-based cross entity and cross retailer return data integration service provides interfaces to the retailers and the entities for querying the data store, defining reports from the data store, and receiving custom notifications from the data store. The cloud-based cross entity and cross retailer return data integration service may enforce security restrictions within the interfaces, such that some entities are not allowed to view data within the data store associated with other entities.

At 340, the cloud-based cross entity and cross retailer return data integration service processes a fraud workflow using the data store based on detection of the current item return transactions or based on detecting current purchase transactions.

In an embodiment of 340, at 341, the cloud-based cross entity and cross retailer return data integration service identifies a fraud trend or a fraud pattern and reports the fraud trend or the fraud pattern to the retailers and the entities.

In an embodiment of 340, at 342, the cloud-based cross entity and cross retailer return data integration service scores the current item return transactions, compares fraud scores for the current item return transactions against known fraudulent scores for known fraudulent item return transactions, and causes possible fraud indications to be provided to the transaction terminals 120 during the current item return transactions based on the comparisons.

In an embodiment of 340, at 350, the cloud-based cross entity and cross retailer return data integration service determines that a select current item return transaction occurring at a select transaction terminal 120 of a select retailer is associated with a particular purchase transaction where a particular item of the select current item return transaction was purchased at a discounted price. The cloud-based cross entity and cross retailer return data integration service then causes the particular purchase transaction and/or the discounted price to be provided to the select transaction terminal 120 during the select current item return transaction. It is noted that the particular purchase transaction may have been with a different retailer than the retailer performing the select current item return transaction, such that cloud-based cross entity and cross retailer return data integration service is able to link that transaction to the discounted price and alert the retailer processing the current item return transaction that the corresponding item was not purchased with that retailer or was purchased at a different store of that retailer, which had the discounted price when the item was originally purchased.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
receiving item return data associated with a return of an item from a retailer during a current item return transaction;
identifying an entity other than the retailer from the item return data;
obtaining an item return workflow associated with the entity; and
processing the item return workflow causing select data from the item return data to be delivered to the entity.

2. The method of claim 1 further comprising:
maintaining the item return data in a data store along with other item return data associated with the retailer and associated with other retailers for other returns.

3. The method of claim 2, wherein maintaining further includes maintaining purchase transaction data in the data store associated with the retailer and associated with the other retailers for purchase transactions.

4. The method of claim 3 further comprising:
providing interfaces for querying and mining the data store to the retailer, the other retailers, the entity, and other entities associated with the return, the other returns, and the purchase transactions.

5. The method of claim 1 further comprising:
obtaining a fraud workflow associated item return transactions that span multiple retailers and associated with purchase transactions that span the multiple retailers, wherein the multiple retailers comprise the retailer and other retailers; and
processing the fraud workflow based on the item return data for the item return at the retailer.

6. The method of claim 5 further comprising:
identifying a fraud pattern or a fraud trend from the item return transactions and the purchase transactions based on the processing of the fraud workflow; and
reporting the fraud pattern or the fraud trend to the multiple retailers, the entity, and other entities associated with the item return transactions and the purchase transactions.

7. The method of claim 5 further comprising:
identifying an original purchase transaction for the item based on the processing of the fraud workflow;
determining a promotional price was given for the item with the original purchase transaction; and
alerting the retailer to the original purchase transaction and the promotional price during the current item return transaction for the return of the item at a transaction terminal of the retailer.

8. The method of claim 1, wherein identifying further includes obtaining an entity identifier for the entity from a Universal Product Code (UPC) included within the item return data for the item.

9. The method of claim 1, wherein obtaining further includes selecting the item return workflow from a plurality of item return workflows associated with the entity based on an item type assigned to the item and included within the item return data.

10. The method of claim 1, wherein processing further includes providing the select data to an inventory system or a schedule/delivery system of the entity through an Application Programming Interface (API).

11. The method of claim 1, wherein processing further includes providing the select data as a current total of returns for the item that is associated with the entity and that is occurring at the retailer or occurring at a custom aggregation of other retailers within a current period of time, wherein the custom aggregation and the current period of time defined within the item return workflow for the entity.

12. A method, comprising:
maintaining a data store as an aggregation of item return transactions and purchase transactions that span retailers and entities, wherein the entities comprise manufacturers, suppliers, distributors, and Consumer Packaging Goods (CPG) associated with items that are sold by the retailers and that are returned by consumers to the retailers;
selectively obtaining and processing item return workflows customized for the corresponding entities using the data store and based on detecting current item return transactions being added to the data store while the current item return transactions are being processed by transaction terminals of the corresponding retailers; and
providing interfaces to the retailers and the entities for querying the data store, defining reports from the data store, and receiving notifications from the data store.

13. The method of claim 12 further comprising:
processing a fraud workflow using the data store based on detecting the current item return transactions or based on detecting current purchase transactions.

14. The method of claim 13, wherein processing the fraud workflow further includes identifying a fraud trend or a fraud pattern and reporting the fraud trend or the fraud pattern to the retailers and the entities.

15. The method of claim 13, wherein processing the fraud workflow further includes scoring the current item return transactions, comparing fraud scores obtained from the scoring against known fraud scores for known fraudulent item return transactions, and causing possible fraud indications to be provided to the transaction terminals during the current item return transactions based on the comparing.

16. The method of claim 12 further comprising:
determining that a select current item return transaction occurring at a select transaction terminal of a select retailer is associated with a particular purchase transaction where a particular item associated with the select current item return transaction was purchased at a discounted price; and
causing the particular purchase transaction or the discounted price to be provided to the select transaction terminal during the select current item return transaction.

17. The method of claim 12, wherein selectively obtaining and processing further includes delivering select data associated with processing a select item return workflow to an inventory system or a schedule/delivery system as input to the inventory system or the schedule/delivery system using an Application Programming Interface (API) of the inventory system or the schedule/delivery system.

18. The method of claim 12, wherein selectively obtaining and processing further includes utilizing item return data from the data store that spans multiple ones of the retailers when processing a particular item return workflow for a particular entity based on custom conditions defined in the particular item return workflow.

19. A system, comprising:
a cloud processing environment comprising at least one server;
the at least one server comprising a processor and a non-transitory computer-readable storage medium;
the non-transitory computer-readable storage medium comprises executable instructions; and
the executable instructions when executed on the processor from the non-transitory computer-readable storage medium cause the processor to perform operations comprising:
receiving a notification from a Point-Of-Sale (POS) system that a return for at least one item was initiated on a device operated by or operated on behalf of a consumer that is returning the at least one item to a retailer associated with the POS system;
obtaining item return data for the return and retailer data for the retailer;
identifying at least one entity associated with providing, supplying, or delivering the at least one item to the retailer for resale to the consumer from the item return data and the retailer data;
obtaining at least one workflow associated with the at least one entity; and
processing the at least one workflow and delivering select data determined from processing the at least one workflow to the at least one entity.

20. The system of claim 19, wherein the executable instructions when executed on the processor from the non-transitory computer-readable storage medium further cause the processor to perform operations comprising:
processing a fraud workflow utilizing the item return data, other item return data associated with the retailer and different retailers, and processing the fraud workflow further utilizing purchase transaction data associated with the retailer and the different retailers based on the receiving of the notification;
identifying a fraud pattern or a fraud trend based on processing the fraud workflow; and
alerting the retailer and the different retailers to the fraud pattern or the fraud trend.
